(19) United States
(12) Patent Application Publication
(10) Pub. No.: US 2009/0096561 A1
(43) Pub. Date: Apr. 16, 2009

(54) Rare earth bonded magnet and production method thereof

(75) Inventors: Noboru Menjo, Kitasaku-gun (JP); Kinji Uchiyama, Kitasaku-gun (JP); Yuki Takeda, Kitasaku-gun (JP); Osamu Kobayashi, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., KITASAKU-GUN (JP)

(21) Appl. No.: 12/078,038

(22) Filed: Mar. 26, 2008

(30) Foreign Application Priority Data
Oct. 12, 2007 (JP) 2007-266554

(51) Int. Cl. H01F 7/02; H01F 3/08

(52) U.S. Cl. 335/302; 29/608

(57) ABSTRACT

In order to achieve excellent heat resistance, durability and weatherability for use in an extended range of temperature environments, a rare earth bonded magnet is formed such that a material mixture comprising: a rare earth magnetic powder having a particle diameter ranging from 30 μm to 500 μm; a resin binder constituted by a thermosetting resin; and an organic phosphorous compound, is compression-molded and hardened, wherein the organic phosphorous compound is uniformly dispersed in the resin binder.

### BACKGROUND OF THE INVENTION

1. Field of the Invention

The present invention relates to a rare earth bonded magnet which is formed principally of a rare earth magnetic powder and combined with a resin binder, and relates particularly to a rare earth bonded magnet which is formed by compression molding, and which is used in a rotary equipment, such as a motor, mounted on a vehicle and therefore is required to be heat resistant, durable, and weather resistant in severe conditions such as in a hot environment. And, the present invention relates further to a production method of such a rare earth bonded magnet.

2. Description of the Related Art

A rare earth magnet has excellent magnetic properties and therefore is extensively used in rotary equipments or elements, general home electric appliances, audio equipments, medical equipments, industrial instruments, and the like. Especially, a rare earth bonded magnet which is formed of a rare earth magnetic powder combined with a resin binder is highly flexible in terms of figuration and so helps to reduce the size and enhance the performance in the usages described above.

There are two main types of processes for molding a rare earth bonded magnet, compression molding and injection molding. While the injection molding is flexible in figuration, the compression molding, which is less flexible in figuration than the injection molding, is capable of producing a rare earth bonded magnet having a high magnetic powder content and thus achieving excellent magnetic properties.

The rare earth magnet is also used in vehicles (this usage is referred to as “automotive application”). For a bonded permanent magnet for automotive application, a ferrite magnetic powder has been used which is highly heat resistant, durable, and weatherable. Such the ferrite permanent magnet, however, exhibits a relatively low spontaneous magnetization or magnetic force and therefore needs to be large in volume in order to produce a necessary magnetic flux. Under the circumstances, a request is being made for a higher output along with downsizing, and the rare earth magnetic powder, which has a high spontaneous magnetization and can produce a high output even with a small volume, is increasingly replacing the ferrite magnetic powder.

Since automobiles are exposed to various environmental conditions, the permanent magnet for automotive application is required to exhibit adequate magnetic properties under a wide range of temperatures, that is to say, must not be demagnetized substantially against temperature changes while having heat resistance, durability and weatherability.

The ferrite magnetic powder and the rare earth magnet power have their respective advantages and disadvantages. The ferrite magnetic powder is hardly demagnetized at high temperatures but is subject to demagnetization at less than room temperature. On the other hand, the rare earth magnetic powder, while not demagnetized at low temperatures, is substantially demagnetized at high temperatures thus facing a heat demagnetization problem. Accordingly, suppression of heat demagnetization is necessary when using the rare earth magnetic powder.

The demagnetization of the rare earth magnetic powder is attributable to magnetic aftereffect caused by heat fluctuation and to deterioration caused by oxidation of the powder itself. For example, in Nd—Fe—B rare earth permanent magnet which is formed principally of neodymium (Nd), iron (Fe) and boron (B), Nd₂Fe₁₄B as a main phase, and grain boundary phases (N-rich phase and B-rich phase) present around main phase crystal grain are easily subjected to oxidation. By the oxidation degradation of the phases, the basic magnetic properties, such as remanent magnetization Br and intrinsic coercive force Hcj, are lowered, which results in deteriorating the performance characteristics (rotation torque, and the like) of rotary equipment, like a motor. Consequently, anti-oxidation technology for the rare earth magnetic powder is an important factor to determine the magnetic properties of a resulting magnet and further the performance characteristics of rotary equipment, such as a motor, using the magnet.

Coating the rare earth magnet, for example, with an epoxy resin is one technique for preventing oxidation degradation. With an epoxy resin coating layer provided on the surface of the rare earth bonded magnet, oxygen or moisture in the air is basically prohibited from making contact with the surface of the rare earth magnet thus prevented from making contact with the surface of the magnetic powder or making inroads thereinto. However, since a slight amount of oxygen transmits through the coating layer of an epoxy resin, the rare earth bonded magnet is more and more likely to suffer from oxidation after a long period of usage. Also, voids may possibly be present in the material mixture containing the magnetic powder, and an air held in the voids and containing oxygen or moisture may make contact with the magnetic powder. Especially, a rare earth bonded magnet produced by compression molding often has, other than the magnetic powder and the resin binder, void portions to occupy more than 10 percent of its whole body. Thus, it is possible for the magnetic powder to make contact with oxygen.

Consequently, it is necessary to apply resin coating or heat treatment to the individual magnetic powder (grain). For example, Japanese Patent Application Laid-Open No. 2001-244106 discloses a surface-treated rare earth magnetic powder and a method for such the surface treating, where an anti-oxidation film of salt of an organic phosphonic acid is formed at the surface of the rare earth magnetic powder (grain) thereby preventing corrosion and oxidation. Also disclosed therein is a method of mixing the surface-treated magnetic powder with resin and producing a rare earth bonded magnet out of the mixture by an injection or compression molding machine.

Also, Japanese Patent Application Laid-Open No. H6-349617 discloses a rare earth bonded magnet which includes a resin binder selectively mixed with an organic phosphorous compound so as to suppress oxidation degradation, whereby the rare earth bonded magnet can be corrosion resistant to become excellent in mechanical strength thus maintaining a high reliability for a long time of usage.

And, Japanese Patent No. 3139826 discloses a rare earth bonded magnet which has excellent magnetic properties and excellent oxidation resistance even at high temperatures. The rare earth bonded magnet is formed of a material mixture produced such that a rare earth element-iron-nitrogen magnetic powder, an anti-oxidant agent constituted by an organic phosphorous compound, and a thermosetting resin are mixed together.

The aforementioned Japanese Patent Application Laid-Open No. 2001-244106 relates principally to an injection molding method though a compression molding method is mentioned therein. In the compression molding, the rare earth magnetic powder is likely to be crushed thereby producing non-treated surface of the powder to be exposed inside the magnet. In such a case, the non-treated surface of the powder may be coated with the thermosetting resin as a binder, but a slight amount of oxygen transmits through the coating layer of the resin as described above. Accordingly, after a long period of usage, oxidation degradation of a main phase or a grain boundary phase is likely to happen at such the surface not duly treated but possibly coated with the resin, which results in causing deterioration of the magnetic properties.

The rare earth bonded magnet disclosed in the aforementioned Japanese Patent Application Laid-Open No. H6-349617 is made of a material mixture produced such that a rare earth magnetic powder and a resin binder mixed selectively with an organic phosphorous compound are mixed together, and therefore is excellent in corrosion resistance and mechanical strength. However, the patent document describes that corrosion is caused by chlorine produced such that halogen ion, particularly chlorine ion contained in epoxy resin reacts with moisture in the air, and does not teach nor suggest a solution in view of heat demagnetization of a rare earth bonded magnet exposed in high temperature environments.

The rare earth bonded magnet disclosed in the aforementioned Japanese Patent No. 3139826 is formed of the material mixture which, as described above, is prepared such that a rare earth element-iron-nitrogen magnetic powder, an anti-oxidant agent constituted by an organic phosphorous compound, and a thermosetting resin are mixed together, and therefore is oxidation resistant in high temperature environments. However, the above-described material mixture of the rare earth bonded magnet to which the patent document specifically refers is a resin composite containing a rare earth element-iron-nitrogen magnetic powder, and the patent document fails to teach or suggest a solution achieved by improving heat resistance of an arbitrary material mixture of a rare earth bonded magnet, particularly a material mixture containing neodymium (Nd), iron (Fe), boron (B), and the like as a primary component. Also, the patent document, while referring to a solution to oxidation degradation of magnetic powder in process, fails to teach or suggest a solution to heat demagnetization of the magnet in use in high temperature environments, and oxidation resistance under still higher temperature environments, for example 180 degrees C. (automotive application environments), is not achieved.

### SUMMARY OF THE INVENTION

The present invention has been made in light of the circumstances described above, and it is an object of the present invention to provide a rare earth bonded magnet which is excellent in heat resistance and therefore has its magnetic properties inhibited from being deteriorated due to oxidation degradation or heat demagnetization in high temperature environments.

According to a first aspect of the present invention, there is provided a rare earth bonded magnet which is compression-molded of a material mixture including: a rare earth magnetic powder having a particle diameter ranging from 30 μm to 500 μm; a resin binder constituted by a thermosetting resin; and an organic phosphorous compound, wherein the organic phosphorous compound is uniformly dispersed in the resin binder.

In the first aspect of the present invention, the content of the resin binder may range from 0.5 to 5.0 percent by weight of the rare earth magnetic powder.

In the first aspect of the present invention, the organic phosphorous compound may be either a phosphite ester or a phosphate ester, and the content of the organic phosphorous compound may range from 0.05 to 2.0 percent by weight of the rare earth magnetic powder.

In the first aspect of the present invention, the material mixture may further include a coupling agent, and the total content of the resin binder, the organic phosphorous compound and the coupling may range from 0.56 to 10.0 percent by weight of the rate earth magnetic powder.

In the first aspect of the present invention, the rare earth bonded magnet may be for automotive application.

According to a second aspect of the present invention, there is provided a method of producing a rare earth bonded magnet, which includes the steps of: dissolving a thermosetting resin as a resin binder, a hardening agent, and an organic phosphorous compound in an organic solvent thereby preparing a solution where the organic phosphorous compound is uniformly dispersed; mixing the solution with a rare earth magnetic powder which has a particle diameter ranging from 30 μm to 500 μm thereby forming a material mixture; volatilizing the organic solvent thereby drying the material mixture; crushing the dried material mixture, and mixing a lubricating agent in the material mixture crushed; molding the crushed material mixture by compression at a predetermined pressure thereby forming a green compact; and heating the green compact to a predetermined temperature for hardening thus obtaining a finished rare earth bonded magnet.

In the second aspect of the present invention, the content of the resin binder may range from 0.5 to 5.0 percent by weight of the rare earth magnetic powder. In the second aspect of the present invention, the content of the organic solvent may range from 50 to 200 percent by weight of the rare earth magnetic powder.

In the second aspect of the present invention, the organic phosphorous compound may be either a phosphite ester or a phosphate ester, and the content of the organic phosphorous compound may range from 0.05 to 2.0 percent by weight of the rare earth magnetic powder.

And, in the second aspect of the present invention, the predetermined pressure for molding may range from 0.1 to 1.5 Gpa.

According to the present invention, a rare earth bonded magnet is provided which is excellent in heat resistance and in which the particle surface of magnetic power exposed due to crushing at the time of compression molding is covered by a resin binder containing an organic phosphorous compound dispersed uniformly during thermosetting process, whereby the deterioration of the magnetic properties of a resulting magnet due to oxidation degradation or heat demagnetization is inhibited in high temperature environments. Also, the method of such the rare earth bonded magnet is provided.

### DETAILED DESCRIPTION OF THE INVENTION

Exemplary embodiments of the present invention will hereinafter be described.

A first embodiment of the present invention pertains to a rare earth bonded magnet produced such that a mixture as material, which consists of a rare earth magnetic powder which has a particle diameter ranging from 30 μm to 500 μm, a resin binder, and an organic phosphorous compound, is molded by compression, heated and hardened, where the organic phosphorous compound is uniformly dispersed in the resin binder. First, description will be made of the abovementioned components of the mixture as material.

### 1. Rare Earth Magnetic Powder:

In the present embodiment, the particle of the rare earth magnetic powder preferably has a particle diameter ranging from 30 μm to 500 μm, more preferably from 50 μm to 250 μm. If the particle diameter is less than 30 μm, the specific surface area of the particle becomes large, and therefore it is highly possible that the resulting magnet itself is oxidized, which makes it difficult to achieve a magnet having an excellent heat resistance. On the other hand, if the particle diameter is more than 500 μm, the specific surface area of the particle becomes small, but the diameter size is too large to properly compression-mold the magnetic powder into a ring magnet having a thickness of less than 1 mm, thus proving that such the magnetic powder is not suitable for making of a magnet by compression molding. Also, the particle size distribution of a rare earth magnetic powder is preferably dispersed to some extent to thereby ensure a good moldability when using a slight amount of a resin binder (to be described later). For example, it is preferable that the average particle diameter of the magnetic powder ranges from 75 μm to 125 μm, and the magnetic powder having such the particle diameter accounts for 50 percent by weight of the total. This is because if the average particle diameter of the magnetic powder is less than 75 μm or more than 125 μm, the mixture is caused to degrade in terms of flowability thus failing to achieve a good moldability.

The rare earth magnetic powder is preferably made of alloy including a rare earth element and a transitional metal. Counted among such the alloy are: for example, an Sm—Co alloy such as SmCo₅ and Sm₂TM₁₇ (where TM is a transitional metal); an R—Fe—B alloy such as Nd—Fe—B, Pr—Fe—B, Nd—Pr—Fe—B, Ce—Nd—Fe—B and Ce—Pr—Nd—Fe—B (where R is at least one rare earth element including Y); and an Sm—Fe—N alloy such as Sm₂Fe₁₇N₃. The rare earth magnetic powder may consist of one or more of the alloys mentioned above so as to have respective advantages thus achieving any better magnetic properties. In the R—Fe—B alloy, part of Fe may be substituted by a transitional metal such as Co and Ni. Included among the rare earth elements of the magnetic powder are Y, La, Ce, Pr, Nd, Pm, Sm, Eu, Gd, Tb, Dy, Ho, Er, Tm, Yb and Lu, and one or more of these elements may be contained. Also, included among the transitional metals are Fe, Co, Ni and the like, and one or more of these metals may be contained. And, for improving the magnetic properties, the magnetic powder may contain B, Al, Mo, Cu, Ga, Si, Ti, Ta, Zr, Hf, Ag, Zn and the like. The present invention is not limited to any specific method of preparing the rare earth magnetic powder.

### 2. Resin Binder (Thermosetting Resin):

A resin binder used in the present embodiment is constituted by a thermosetting resin, such as epoxy resin, phenolic resin, polyester, silicone resin, polyurethane, and the like. In case of the rare earth bonded magnet made by compression molding, epoxy resin, phenolic resin and silicone resin are preferred among the abovementioned resins because of its excellent heat resistance, wherein epoxy resin is the most preferable. The thermosetting resin may be either solid (powdery) or liquid at room temperature.

The present invention is not limited to a particular type of epoxy resin insofar as at least one epoxy group is contained in the molecule. The epoxy resin may have a basic chemical structure of, for example, bisphenol A glycidyl ether, bisphenol A glycidyl ester, aromatic resin epoxy compound, cyclic olefin epoxy compound, and the like.

Also, the present invention is not limited to a particular type of hardener and/or accelerator for the thermosetting resin. For example, amine hardener, dicyandiamide and its derivative, phenol and its derivative, isocyanate, block isocyanate, imidazole and its derivative, and the like may be selectively used.

The weight content of the thermosetting resin ranges from 0.5 to 5.0 percent by weight of the rare earth magnetic powder, and more preferably from 1.0 to 3.0 percent by weight thereof. A too low content of the thermosetting resin makes it difficult to mold the magnetic powder mixture by compression, and on the other hand a too high content thereof degrades the magnetic properties of the resulting magnet.

### 3. Organic Phosphorous Compound:

In the present embodiment, an organic phosphorous compound is constituted by a phosphite ester or phosphate ester and has its weight preferably ranging from 0.05 to 2.0 percent by weight of the rare earth magnetic powder.

The present invention is not limited to a particular type of organic phosphorous compound insofar as at least one phosphorous atom is contained in the molecule, wherein the abovementioned phosphite ester and phosphate ester are preferable. Examples of the phosphite ester are trioctylphosphite, triphenylphosphite, tricresylphosphite, bis-2-ethylhexylphosphite, tridecylphosphite, diethylhydrogenphosphite, dibutylhydrogenphosphite, dilaurylhydrogenphosphite, diphenylmonodecylphosphite, trilauryltrithiophosphite and diphenyhydrogenphosphite, and examples of the phosphate ester are triphenylphosphate, triethylphosphate, tributylphosphate, tridecylphosphate, tricresylphosphate, trioctylphosphate, tristearylphosphate, dibutylphosphate, monoisodecylphosphate, monobutylphosphate and butylpyrophosphate.

The weight content of the organic phosphorous compound, while preferred to range from 0.05 to 2.0 percent by weight of the rare earth magnetic powder as describe above, more preferably ranges from 0.05 to 1.0 percent by weight thereof. A too low content of the organic phosphorous compound results in failure to achieve heat resistance, durability and weatherability as targeted, and a too high content thereof degrades the magnetic properties of the resulting magnet.

The aforementioned components, specifically, the rare earth magnetic powder, the resin binder (thermosetting resin) and the organic phosphorous compound, which are weighed as described above, are mixed together, and a mixture as material is produced. The details of the mixture will be described later.

Coupling Agent:

The mixture may further contain a coupling agent where necessary. In one example of the present embodiment, a coupling agent is added to the mixture described above. Addition of a coupling agent is effective in lowering the decrease ratio (%) of a resulting magnet. The present invention is not limited to a particular type of coupling agent insofar as the chemical composition falls under the system shown by the following general expression: R₍ₘ₋ₙ₎-M-X₍ₙ₎ where R is an organic group of one or more kinds having hydrocarbon group, X is a hydrolysable group, M is a metal element constituted by one of Si, Al, Ti and Zr, m is the number of binding arms of the metal element M and defined by an integer from 2 to 4, and n is an integer from 1 to 4. If the organic group R contains two or more kinds, the two or more kinds of organic groups may be the same or different from one another. The hydrocarbon group is an alkyl group, an allyl group or an aryl group, that has a carbon number of 1 to 15, and may be straight-chained, branched or looped, and the hydrolysable group X is an alkoxy group, a glycol group or the like, that has a carbon number of 1 to 5.

The coupling agent essentially contains one of metal elements Si, Al, Ti and Zr, and at least one binding arm of the one metal element must have a hydrolysable group. The coupling agent may be, for example, a silane coupling agent, an aluminum coupling agent, a titanate coupling agent, or a zirconate coupling agent.

The weight content of the coupling agent preferably ranges from 0.01 to 3.0 (more preferably from 0.5 to 1.5) percent by weight of the rare earth magnetic powder, making it that the total weight content of the thermosetting resin, the organic phosphorous compound and the coupling agent preferably ranges from 0.56 to 10.0 (more preferably from 1.0 to 5.0) percent by weight of the rare earth magnetic powder. Too much addition of the coupling agent can possibly degrade the mechanical strength of the resulting magnet. By following the preferable content ranges described above, the decrease ratio of coercive force of the resulting rare earth bonded magnet can be lowered while achieving excellent heat resistance, durability and weatherability.

Description will now be made on a second embodiment of the present invention, which pertains to a preferable method of producing the rare earth bonded magnet of the present invention. A redundant explanation of the details of the components of the rare earth bonded magnet will be omitted as appropriate.

The method of producing the rare earth bonded magnet of the present invention includes the following steps:

Step A, at which a thermosetting resin (as resin binder), a hardening agent, an organic phosphorous compound, and a coupling agent as necessary are dissolved with an organic solvent thereby preparing a solution where the organic phosphorous compound is uniformly dispersed;

Step B, at which a rare earth magnetic powder which has a particle diameter ranging from 30 μm to 500 μm is mixed in the prepared solution thereby forming a mixture;

Step C, at which the organic solvent is volatilized thereby drying the mixture;

Step D, at which the dried mixture is crushed, and an additive agent, for example a lubricating agent, is mixed in the crushed mixture;

Step E, at which the crushed mixture containing the lubricating agent is filled into a molding die of a pressing machine and molded by compression at a predetermined pressure thereby forming a green compact; and

Step F, at which the green compact is heated to a predetermined temperature and hardened thus obtaining a finished rare earth bonded magnet. In the rare earth bonded magnet prepared according to the production steps described above, the organic phosphorous compound is uniformly dispersed in the resin binder.

Each of the steps A to F of the production method will be further explained.

### [Step A and Step B]

The organic solvent is the most preferred solvent if the thermosetting resin is solid (powdery) at room temperature. Using the organic solvent, the thermosetting resin, the organic phosphorous compound, and the coupling agent added as necessary can be wet mixed and therefore uniformly dispersed. Any type of organic solvent, specifically, for example, acetone, methylethylketone, toluene, or xylene may be used in which the thermosetting resin, the organic phosphorous compound, and the coupling agent can be readily dissolved.

The amount of the organic solvent is preferably set to range from 50 to 200 (more preferably from 80 to 120) percent by weight of the rare earth magnetic powder with which the organic solvent is mixed at Step B. A too small amount of the organic solvent hinders the uniform dispersion of the thermosetting resin, the organic phosphorous compound, and possibly the coupling agent consequently failing to achieve heat resistance and durability as aimed, and a too large amount thereof results in requiring a longer time for volatilizing the organic solvent at the subsequent step (Step C).

Also, the content of the thermosetting resin is set to range from 0.5 to 5.0 percent by weight of the rare earth magnetic powder. Further, the organic phosphorous compound is a phosphite ester or phosphate ester, and the content of the organic phosphorous compound is set to range from 0.05 to 2.0 percent by weight of the rare earth magnetic powder.

### [Step C]

After confirming the uniform dispersion of the components in the solution at Step B, the organic solvent is volatilized preferably at a temperature ranging from room temperature to the boiling point of the solvent (for example, about 56 degrees C. for acetone), and more preferably less than the curing temperature of the thermosetting resin.

### [Step D]

When the organic solvent is volatilized for drying at Step C, the mixture composed of the rare earth magnetic powder, the thermosetting resin, the organic phosphorous compound, and possibly the coupling agent is likely to mass together into a (cake-like) solid state. Accordingly, the dried mixture is crushed as appropriate such that the uncured mixture is broken to an extent that the rare earth magnetic powder is not fractured. This crushing process can be duly performed by a general crushing machine, such as a cutter mill.

An additive agent, such as a lubricating agent (for example, stearate acid, fat acid, alumina, silica and titania), a plasticizing agent (for example, stearate acid and fat acid), or other molding aid, may be added to the crushed mixture where necessary. Since addition of the lubricating agent is effective in enhancing the flowability at molding process, equivalent properties can be achieved with addition of a reduced amount of a resin binder, and also the compression molding process can be conducted at a lowered pressure. Addition of the plasticizing agent generates the same effect. It is preferable to add the lubricating or plasticizing agent after the mixture is formed by mixing together the rare earth magnetic powder, the thermosetting resin, the organic phosphorous compound, and possibly the coupling agent. The added amount of the lubricating agent preferably ranges from 0.05 to 0.3 percent by weight of the mixture, and the added amount of the plasticizing agent preferably ranges from 0.01 to 0.2 percent by weight of the mixture.

### [Step E]

The crushed mixture possibly containing the additive agent as described above is filled into a molding die of a pressing machine (molding machine) and molded preferably at a pressure ranging from 0.1 to 1.5 Gpa. While this compression molding may be performed by room temperature pressing or warm pressing, the room temperature pressing is preferable (more preferably at a low humidity) because the mixture can be uniformly filled into the molding die at room temperature.

### [Step F]

The green compact formed at Step E is heated to more than the curing temperature of the thermosetting resin thereby hardening the thermosetting resin. If the thermosetting resin is an epoxy resin, the hardening process is performed at a temperature ranging from 150 to 190 degrees C. for 10 to 100 minutes.

The rare earth bonded magnet according to the first embodiment of the present invention is produced by the above-described Steps A to F.

Invention examples from the rare earth bonded magnets according to the first embodiment of the present invention and comparison examples from conventional rare earth bonded magnets will be explained. Two invention examples 1 and 2 are each produced such that a mixture prepared by adding an organic phosphorous compound to the Nd—Fe—B magnetic powder described above is compression-molded, heated and hardened, where the example 1 contains no coupling agent while the example 2 contains a coupling agent (refer to Table 2). Three comparison examples 1, 2 and 3 are each produced such that a mixture containing the Nd—Fe—B magnetic powder having the same composition as that of the invention examples 1 and 2 but containing no organic phosphorous compound is compression-molded, heated and hardened (refer to Table 3).

The invention examples 1 and 2 and the comparison examples 1, 2 and 3 will hereinafter be detailed with reference to Table 1, 2 and 3. All of the invention examples 1 and 2 and the comparison examples 1, 2 and 3 use the same Nd—Fe—B magnetic powder that has the magnetic properties shown below in Table 1.

TABLE 1
Magnetic properties of the Nd—Fe—B magnetic powder

| Br(T) | Hcj(Ka/m) | HcB(kA/m) | (BH)max(kJ/m³) |
|---|---|---|---|
| 0.93 | 832 | 530 | 120 |

Description will first be made on the invention examples 1 and 2 with reference principally to Table 2.

### INVENTION EXAMPLE 1

The invention example 1 was made of a mixture containing an isotropic Nd—Fe—B magnetic powder having the magnetic properties shown in Table 1 and other components shown in the left column of Table 2. Since an epoxy resin as a resin binder and a hardening agent are in a powder state, 5 g of methylethylketone as an organic solvent was used. The aforementioned other components, specifically a phenolnovolak epoxy resin as a resin binder, an amine hardener as a hardening agent, an imidazole derivative as a hardening accelerating agent, and a dibutylhydrogenphosphite as an organic phosphorous compound as shown in Table 2, were added in the methylethylketone solvent, and the aforementioned components dissolved in the methylethylketone were mixed with the isotropic Nd—Fe—B magnetic powder (refer to Table 1). After the components and the isotropic Nd—Fe—B magnetic powder were uniformly mixed together, the methylethylketone was volatilized in the room temperature condition, whereby the mixture was dried. The dried mixture was crushed, and a stearate calcium as a lubricating agent was added to the crushed mixture thus forming a final mixture for the example 1.

The final mixture was molded by a pressing machine into a green compact having a solid circular cylinder shape with a diameter of 10 mm and a length of 7 mm, and into another green compact having a ring shape with an outer diameter of 20 mm, an inner diameter of 18 mm and a length of 4 mm. The green compacts were hardened at a temperature of 190 degrees C., where the resulting rare earth bonded magnets have a molding density of 5.9 g/cm³.

### INVENTION EXAMPLE 2

The invention example 2 was made of a mixture containing the same isotropic Nd—Fe—B magnetic powder as that of the invention example 1 and other components shown in the right column of Table 2. Since an epoxy resin as a resin binder and a hardening agent are in a powder state, 5 g of methylethylketone as an organic solvent was used. The aforementioned other components, specifically a phenolnovolak epoxy resin as a resin binder, an amine hardener as a hardening agent, an imidazole derivative as a hardening accelerating agent, a dibutylhydrogenphosphite as an organic phosphorous compound, and a 2-ethylhexanoyloxytri (2-proxy) titan as a coupling agent as shown in Table 2, were added in the methylethylketone solvent, and the aforementioned components dissolved in the methylethylketone were mixed with the isotropic Nd—Fe—B magnetic powder (refer to Table 1). After the components and the isotropic Nd—Fe—B magnetic powder were uniformly mixed together, the methylethylketone was volatilized in the room temperature condition, whereby the mixture was dried. The dried mixture was crushed, and a stearate calcium as a lubricating agent was added to the crushed mixture thus forming a final mixture for the example 2.

The final mixture was molded by a pressing machine into a green compact having a solid circular cylinder shape with a diameter of 10 mm and a length of 7 mm, and into another green compact having a ring shape with an outer diameter of 20 mm, an inner diameter of 18 mm and a length of 4 mm. The green compacts were hardened at a temperature of 190 degrees C., where the resulting rare earth bonded magnets have a molding density of 5.9 g/cm³.

The weights (g) of the components for the examples 1 and 2 and the weight percents (%) thereof with respect to the total weights (100%) are shown in Table 2. Also, the decrease ratio (%) of total flux, the rating of the radial crushing strength (in terms of practical use), and the decrease ratio (%) of coercive force are shown in Table 2. The same information and data for the comparison examples 1, 2 and 3 except the ratio of coercive force decrease are shown in Table 3.

TABLE 2

| | Invention Example 1 | | | Invention Example 2 | | |
|---|---|---|---|---|---|---|
| | | Weight | Weight | | Weight | Weight |
| | Component | (g) | (%) | Component | (g) | (%) |
| Magnetic powder | Nd—Fe—B magnetic | 200 | 97.51 | Nd—Fe—B magnetic | 200 | 97.07 |
| | powder | | | powder | | |
| Resin binder | Phenolnovolak | 1.57 | 0.77 | Phenolnovolak | 1.57 | 0.76 |
| | epoxy resin | | | epoxy resin | | |
| Hardening agent | Amine hardener | 2.36 | 1.15 | Amine hardener | 2.36 | 1.15 |
| Hardening accelerating agent | Imidazole derivative | 0.07 | 0.03 | Imidazole derivative | 0.07 | 0.03 |
| Coupling agent | Not added | | | 2-ethylhexanoyl | 1.34 | 0.65 |
| | | | | oxytri(2-proxy) titan | | |
| Organic phosphorous | Dibutylhydrogen | 1.0 | 0.49 | Dibutylhydrogen | 0.6 | 0.29 |
| compound | phosphite | | | phosphite | | |
| Lubricating agent | Stearate calcium | 0.1 | 0.05 | Stearate calcium | 0.1 | 0.05 |

| | | |
|---|---|---|
| Decrease ratio (%) of total | 7.5% | 8.9% |
| flux | | |
| Decrease ratio (%) of coercive | 15.3% | 5.8% |
| force | | |
| Radial crushing strength | Excellent (practically usable) | [Good (practically usable)] |
| (relative comparison) | | |

A brief description will be made of the decrease ratio of total flux decrease, the decrease ratio of coercive force and the radial crushing strength.

The all example rare earth bonded magnets having a solid circular cylinder shape, after magnetization, were subjected to a heat test where the cylindrically shaped magnets were left in the high temperature environment (180 degrees C. for 120 hours) in order to determine the heat resistance. The decrease ratios of total flux and coercive force were calculated from the measurement of the total fluxes and the coercive forces both before and after the test (see the third and second rows from the bottom in Table 2).

Also, the all example rare earth bonded magnets having a ring shape underwent a radial crushing strength test (JIS Z2507) where the ring shaped magnets were radially compressed in order to determine the mechanical strength. The test results are indicated by three rating grades; excellent, good (see the bottom row in Table 2) and poor (refer to the bottom row in Table 3).

The magnetic mixtures for the invention examples 1 and 2 contain an organic phosphorous compound, and therefore the decrease ratio of total flux after the heat test is small thus verifying that a high heat resistance and a high durability are provided. Also, it is proven that the invention examples 1 and 2 have mechanical strengths rated “excellent” and “good” respectively as shown by the radial crushing strength and are practically usable in a motor mounted on a vehicle.

The heat test described above indicates that the invention example 2 containing a coupling agent has a lower decrease ratio of coercive force lower than the invention example 1 containing no coupling agent (see the second row from the bottom in Table 2).

Description will now be made on the comparison examples 1, 2 and 3 with reference principally to Table 3.

TABLE 3

| | Comparison Example 1 | | | Comparison Example 2 | | | Comparison Example 3 | | |
|---|---|---|---|---|---|---|---|---|---|
| | | Weight | Weight | | Weight | Weight | | Weight | Weight |
| | Component | (g) | (%) | Component | (g) | (%) | Component | (g) | (%) |
| Magnetic powder | Nd—Fe—B magnetic | 200 | 97.51 | Nd—Fe—B magnetic | 200 | 97.6 | Nd—Fe—B magnetic | 200 | 97.99 |
| | powder | | | powder | | | powder | | |
| Resin binder | Phenolnovolak epoxy | 1.57 | 0.77 | Cresolnovolak epoxy | 2.91 | 1.42 | Phenolnovolak epoxy | 1.57 | 1.16 |
| | resin | | | resin | | | resin | | |
| Hardening agent | Amine hardener | 2.36 | 1.15 | Dicyandiamide | 0.39 | 0.19 | Amine hardener | 2.36 | 0.15 |
| Hardening | Imidazole derivative | 0.07 | 0.03 | Tertiary amine | 0.06 | 0.03 | Imidazole derivative | 0.07 | 0.03 |
| accelerating agent | | | | | | | | | |
| Coupling agent | Isopropyltriiso- | 1 | 0.49 | Neopenthyl(diallyl)- | 1.43 | 0.70 | Not added | | |
| | stearoyl titanate | | | oxytri(dioctyl)- | | | | | |
| | | | | pyrophosphate titanate | | | | | |
| Organic | Not added | | | Not added | | | Not added | | |
| phosphorous | | | | | | | | | |
| compound | | | | | | | | | |
| Lubricating agent | Stearate calcium | 0.1 | 0.05 | Stearate zinc | 0.12 | 0.06 | Stearate calcium | 0.1 | 0.05 |

| | | | |
|---|---|---|---|
| Decrease ratio (%) | 30.2% | 9.8% | 21.4% |
| of total flux | | | |
| Radial crushing | Poor (practically unusable) | Poor (practically unusable) | Excellent (practically usable) |
| strength (relative | | | |
| comparison) | | | |

### COMPARISON EXAMPLE 1

The comparison example 1 contains no organic phosphorous compound while containing an isopropyltriiso-stearoyl titanate (titanate coupling agent) as a coupling agent. Otherwise, the comparison example 1 has the same composition as the invention example 1 or 2. As shown in Table 3, the decrease ratio of total flux of the comparison example 1 after the heat test is as high as 30.2% thus indicating very low heat resistance and durability, and also the mechanical strength thereof based on the radial crushing strength is lower than that of the invention example 1 or 2 and rated as poor. Accordingly, the comparison example 1 is not practically usable for use in a motor exposed to a high temperature, especially for automotive application.

### COMPARISON EXAMPLE 2

The comparison example 2 contains no organic phosphorous compound while containing a neopenthyl (diallyl)-oxytri (dioctyl)-pyrophosphate titanate (titanate coupling agent containing phosphate group) as a coupling agent. The resin binder, hardening agent, hardening accelerating agent and lubricating agent of the comparison example 2 are not the same as those of the invention examples 1 and 2, but have the same or similar effect. The decrease ratio of total flux of the comparison example 2 is substantially comparable to that of the invention example 1 or 2 thus achieving relatively high heat resistance and durability, but the mechanical strength thereof based on the radial crushing strength is low due to addition of a large amount of the coupling agent thus rated as poor, which renders the comparison example 2 practically unusable for automotive application.

### COMPARISON EXAMPLE 3

The comparison example 3 does not contain an organic phosphorous compound nor a coupling agent. Otherwise, the comparison example 3 has the same composition as the invention example 1 or 2. The comparison example 3 has an excellent mechanical strength based on the radial crushing strength, but the heat test indicates that its decrease ratio of total flux is high thus providing lower heat resistance and durability than the invention example 1 or 2, which renders the comparison example 3 practically unusable for use in a high temperature environment.

From the above observation of the decrease ratio of total flux and the mechanical strength based on the radial crushing strength, the invention examples 1 and 2 are superior overall to the comparison examples 1, 2 and 3. That is to say, it is confirmed that the rare earth bonded magnet according to the present invention has better heat resistance, durability and weatherability than the conventional rare earth bonded magnet and therefore can be used in an extended range of temperature environment. Further, an appropriate surface treatment will enhance the properties of the magnet.

1. A rare earth bonded magnet compression molded of a material mixture comprising:
a rare earth magnetic powder having a particle diameter ranging from 30 μm to 500 μm;
a resin binder constituted by a thermosetting resin; and
an organic phosphorous compound, wherein the organic phosphorous compound is uniformly dispersed in the resin binder.

2. A rare earth bonded magnet according to claim 1, wherein a content of the resin binder ranges from 0.5 to 2.0 percent by weight of the rare earth magnetic powder.

3. A rare earth bonded magnet according to claim 1, wherein the organic phosphorous compound is one of a phosphate ester and a phosphate ester, and a content of the organic phosphorous compound ranges from 0.05 to 2.0 percent by weight of the rare earth magnetic powder.

4. A rare earth bonded magnet according to claim 1, wherein the material mixture further comprises a coupling agent, and a total content of the resin binder, the organic phosphorous compound and the coupling rangers from 0.56 to 10.0 percent by weight of the rate earth magnetic powder.

5. A rare earth bonded magnet according to claim 1, wherein the rare earth bonded magnet is for automotive application.

6. A method of producing a rare earth bonded magnet, the method comprising steps of:
dissolving a thermosetting resin as a resin binder, a hardening agent, and an organic phosphorous compound in an organic solvent thereby preparing a solution where the organic phosphorous compound is uniformly dispersed;
mixing the solution with a rare earth magnetic powder which has a particle diameter ranging from 30 μm to 500 μm thereby forming a material mixture;
volatilizing the organic solvent thereby drying the material mixture;
crushing the material mixture dried, and mixing a lubricating agent in the material mixture crushed;
molding the crushed material mixture by compression at a predetermined pressure thereby forming a green compact; and
heating the green compact to a predetermined temperature for hardening thus obtaining a finished rare earth bonded magnet.

7. A method of producing a rare earth bonded magnet according to claim 6, wherein a content of the resin binder ranges from 0.5 to 5.0 percent by weight of the rare earth magnetic powder.

8. A method of producing a rare earth bonded magnet according to claim 6, wherein a content of the organic solvent ranges from 50 to 200 percent by weight of the rare earth magnetic powder.

9. A method of producing a rare earth bonded magnet according to claim 6, wherein the organic phosphorous compound is one of a phosphite ester and a phosphate ester, and a content of the organic phosphorous compound ranges from 0.05 to 2.0 percent by weight of the rare earth magnetic powder.

10. A method of producing a rare earth bonded magnet according to claim 6, wherein the predetermined pressure for molding ranges from 0.1 to 1.5 Gpa.
